(19) United States
(12) Patent Application Publication
(10) Pub. No.: US 2014/0079272 A1
(43) Pub. Date: Mar. 20, 2014

(54) SCALLOP GRIP EARPHONES

(71) Applicant: Puma North America, Inc., Westford, MA (US)

(72) Inventors: Igor Burt, La Jolla, CA (US); Chad Grismer, San Diego, CA (US)

(73) Assignee: PUMA NORTH AMERICA, INC., Westford, MA (US)

(21) Appl. No.: 14/026,294

(22) Filed: Sep. 13, 2013

Related U.S. Application Data
(60) Provisional application No. 61/701,042, filed on Sep. 14, 2012.

(51) Int. Cl. H04R 1/10

(52) U.S. Cl. CPC H04R 1/1066
USPC 381/380

(57) ABSTRACT

The invention generally relates to audio headphones. In certain embodiments, an earbud headphone assembly is provided. The assembly includes a sound chamber and a region on the sound chamber adapted to grip an ear.

### RELATED APPLICATION

The present application claims the benefit of and priority to U.S. Provisional Application No. 61/701,042, filed Sep. 14, 2012.

### FIELD OF THE INVENTION

The invention generally relates to audio headphones.

### BACKGROUND

Typical portable audio devices (i.e., portable MP3 players, cassette players, and CD players) often include a set of headphones that connect to the device. As the headphone industry has progressed, numerous styles of headphones have become available. One of the more popular styles is the earbud style of headphones in which each earbud of the headset is designed to fit within the user's ear. The popularity of the earbud design is attributable to a host of factors, including the relative portability and small size of the earbuds.

The earbud headset is not without problems, however. Typically, the earbuds do not fit comfortably in every user's ear quite the same way. Manufacturers of earbud headphones usually take a “one-size-fits all” approach and simply design the earbud to be slightly larger than the outer ear of the user in order to hold the earbud in place when inserted. Of course, no two users will have an outer ear that is exactly the same. Accordingly, what may fit securely in one user's ear will not fit as securely in another.

Whether the outer ear of the user is too small or too large relative to the size of the earbud, the usual outcome is that the earbud eventually falls out of the user's ear, leading to frustration and interfering with the enjoyment of the portable audio device. In addition, the lack of optimal fit detracts from the sound quality during playback of the audio device. Furthermore, the lack of a secure fit makes conventional earbud assemblies less amenable when used during more physical activities, such as exercise. Accordingly, there is a need for an earbud style headphone with improved fit and audio characteristics.

### SUMMARY

The invention generally relates to earbud headphones with an ear-fitting “scallop” grip. Earbud assemblies of the present invention feature a region on the assembly sound chamber that provides enhanced grip when the assembly is placed in the ear. In certain aspects, the region is a circular band that extends around the sound chamber, thus giving the grip region a “scallop” appearance. A substantial portion of the grip region is able to contact the ear, thereby gripping the ear. The ability of the region to grip the ear is based in part on the materials used to prepare the grip region. The preferred material is able to provide some resistance when the earpiece is moved, i.e., movement of the earpiece will result in friction. Although any material in the art that provides such resistance can be used, preferred embodiments of the invention utilize rubber or a rubber composite. In certain aspects, the grip of the resistance-providing material is further enhanced by protrusions that extend from the surface of the material, for example, ridges that extend from the material surface.

The provided ear bud assembly may also include a housing component that encloses the sound chamber and grip region. The housing component may be configured such that contact between the ear and the grip region is maximized while still providing support to the sound chamber. In other words, a substantial portion of the grip region may extend beyond the housing such that a significant portion of the grip region is still able to contact the ear. In certain embodiments, the housing component is a frame that encloses the sound chamber and grip region.

Accordingly, an earbud assembly is provided. The assembly also includes a sound chamber with a grip region. In certain embodiments, the grip region extends over a portion of the circumference of the sound chamber. In some aspects, the grip region is a band that wraps around the circumference of the sound chamber. In certain aspects, the grip region is prepared from a movement-resistant material. In some embodiments, the movement-resistant material is rubber or a rubber composite. In further embodiments, the movement-resistant material includes a plurality of protrusions on the surface of the movement-resistant material. These protrusions may include, for instance, ridges placed along the grip region. In additional embodiments, the earbud assembly also includes a housing component which encloses the sound chamber and grip region. In some embodiments, the housing component is configured to allow a substantial portion of the cylindrical component to contact the ear. The assembly also includes an ear pad adapted to fit within the ear of the user.

Headphone assemblies in accordance with the invention offer numerous benefits. The grip region provides additional stability when the earbud is placed into the ear, thereby preventing the earbud from falling out. The secure fit also improves sound quality as more sound from the audio device can be directed to the ear in manner suited to the user. In addition, the improved fit of the provided assembly makes it more amenable for use in more physical activities, such as exercise.

Additional features and advantages of exemplary implementations of the invention will be set forth in the following description.

### BRIEF DESCRIPTION OF THE DRAWINGS

FIGS. 1A, 1B, and 1C are front, side, and rear views, respectively, of an embodiment of the invention.

FIG. 2 is an exploded perspective of an embodiment of the invention.

FIGS. 3A and 3B illustrate a movement resistant band of the invention.

### DETAILED DESCRIPTION

The invention provides an earbud headphone assembly encompassing a sound chamber with a region located thereon adapted to grip an ear. The grip region results in the enhanced stability of the provided assembly when the unit is placed into the ear.

The sound chamber is typically a cylindrical component configured for insertion into the ear. The appropriate size can be determined empirically by those skilled in the art.

The body of the sound chamber can be prepared from any suitable material. In certain embodiments, the body of the sound chamber is prepared from plastic or a plastic polymer. The sound chamber may house a speaker capable of converting an audio signal into an audible sound wave. Accordingly, the sound chamber can receive an audio signal from the audio device and convert it into sound. The sound chamber may include components such as coils, magnets, drivers, cones, electronics, and electrical connections that assist in the conversion of the audio signal into an audible sound wave. The exact configuration of these components required in order to produce sound is well-known in the art.

In addition to the internal components, the sound chamber can also include various external components. For example, the sound chamber may include a mesh speaker cover. The mesh speaker cover can be prepared from a variety of materials, including aluminum or plastic. Other embodiments may replace the mesh cover with an open port from which sound exits the chamber. The sound chamber may also be connected to a wire that delivers audio signal from the playback device to the speaker within the sound chamber.

In certain embodiments, the sound chamber features a region that grips the outer ear when the unit is placed within the ear. In certain aspects, the region is a circular band that extends around the circumference of the sound chamber, thus giving the grip region a “scallop” appearance. This grip region is configured such that a substantial portion of the region contacts the ear, thereby securing the earbud assembly in the ear when placed inside. In preferred embodiments, the grip region is prepared from a material that is able to provide some resistance when moved. Accordingly, the material helps the earpiece from falling out the ear. In some instances, the material is able to resist movement due to friction. In some embodiments, the movement-resistance material is a band of material that extends around the entire circumference of the sound chamber, thus providing the assembly with a “scallop” grip. In some embodiments, however, the material extends over less than the total circumference of the sound chamber. As long as an adequate portion of the grip region is able to contact the ear, a grip region of smaller area will not interfere with its intended use.

The movement-resistant material of the grip region can be prepared from any material known in the art suitable for providing grip and impeding movement. In some embodiments, the movement-resistant material is a rubber or a rubber composite, such as silicone rubber.

The movement-resistant material may also include a plurality of protrusions that extend from the surface of the material. The protrusions further secure the device in the ear and resist movement. In some instances, the protrusions are uniformly positioned over the movement-resistant material. In other instances, each protrusion constitutes a ridge that extends along the length of the movement-resistant material.

As contemplated by the invention, the sound chamber along with grip region is configured such that a substantial portion of the grip zone contacts the ear. Accordingly, when the assembly is placed inside the ear, a significant portion of the grip region contacts the outer ear, thereby securing the device in the ear. Therefore, in contrast to conventional earbud headphones, which typically rely on just the ear pad itself to secure the earbud in the ear, the provided assemblies offer an additional surface, i.e., the grip region, to secure the unit in the ear. In certain embodiments, the grip region placed on the sound chamber is configured to be slightly larger than the typical human outer ear, which facilitates securing the device in the ear.

As mentioned above, the movement-resistant material may constitute a band that surrounds the sound chamber. To better accommodate the band, the sound chamber may have a depression, notch, or groove along its surface which accommodates the band. In other embodiments, the sound chamber does not feature the depression and the band simply wraps around the sound chamber without additional accommodation.

The assembly may also include a housing component which encloses the sound chamber and the grip region. Although the housing component encloses the sound chamber and grip region, a significant portion of the grip region is still is exposed in order to contact ear. In certain embodiments, the housing permits the exposure of 10% to 95% of the grip region. In certain aspects, the housing component is a frame enclosing the sound chamber and grip region. In this embodiment, the frame minimally covers the sound chamber and grip region while still enclosing them and providing support.

Further embodiments of the invention typically include an ear pad adapted to fit into an ear. In contrast to conventional earbud headsets, which usually rely on just the ear pad to secure the unit within the ear, the assemblies of the present invention offer an additional surface to stabilize the unit, i.e., the grip region featured on the sound chamber. The ear pad of the present invention is configured to be slightly larger than the typical human outer ear. The appropriate size may be determined empirically by those skilled in the art. Moreover, standard sizes for ear pads in headphone assemblies are well-known in the art.

The ear pad can be prepared from any material known in the art suitable for insertion into the ear, but in general, the ear pad is made from a semi-hard material with a certain amount of flexibility. In certain embodiments, the ear pad is made from rubber or a rubber composite, such as silicone rubber. The hardness of the ear pad is preferably any of 30, 40, and 50 degrees as measured with the JIS hardness scale.

The ear pad is connected to one end of the sound chamber. In certain embodiments, the sound chamber may be equipped with notches or grooves to secure the ear pad onto the sound chamber. The ear pad itself may also include notches or grooves to secure the ear pad onto the sound chamber.

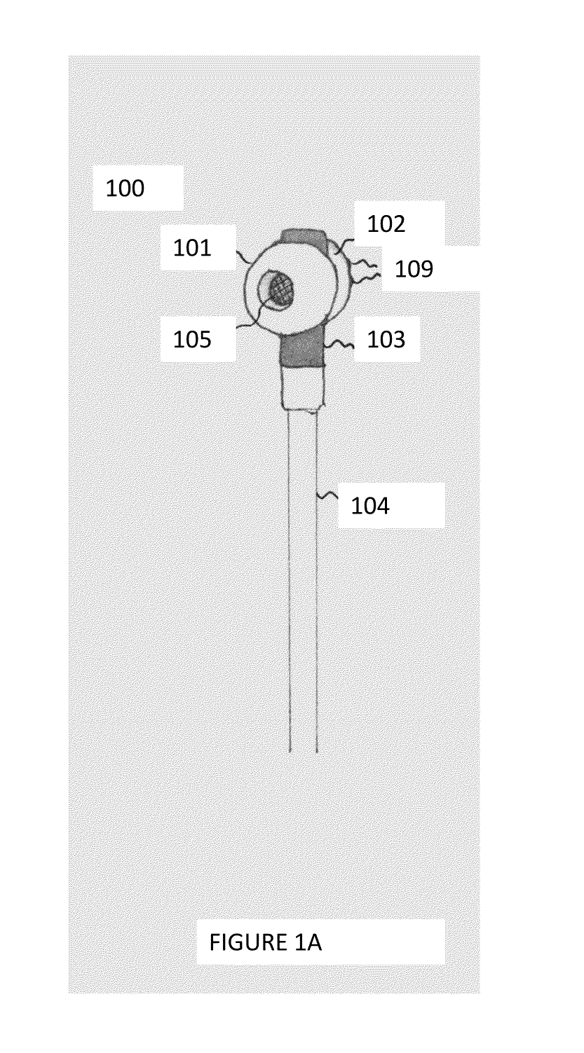

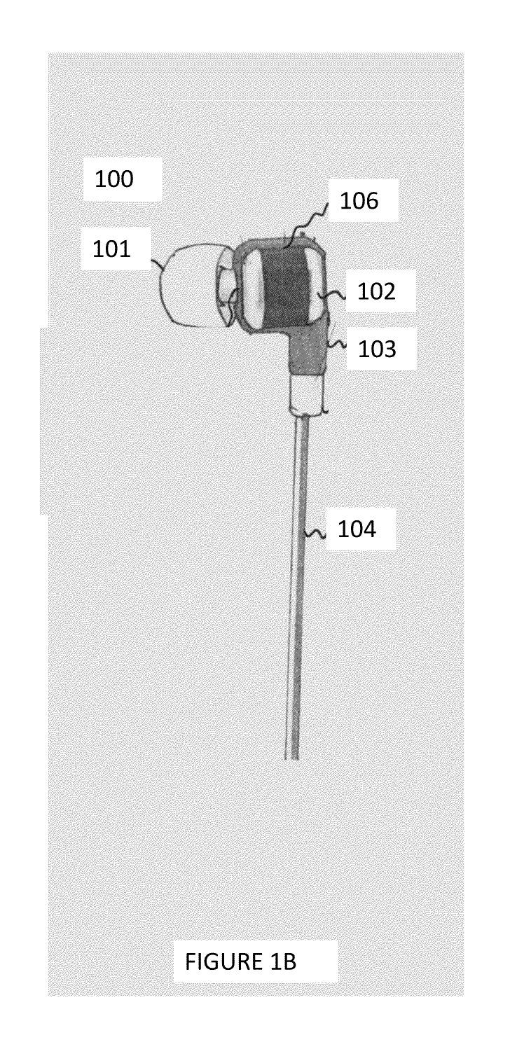

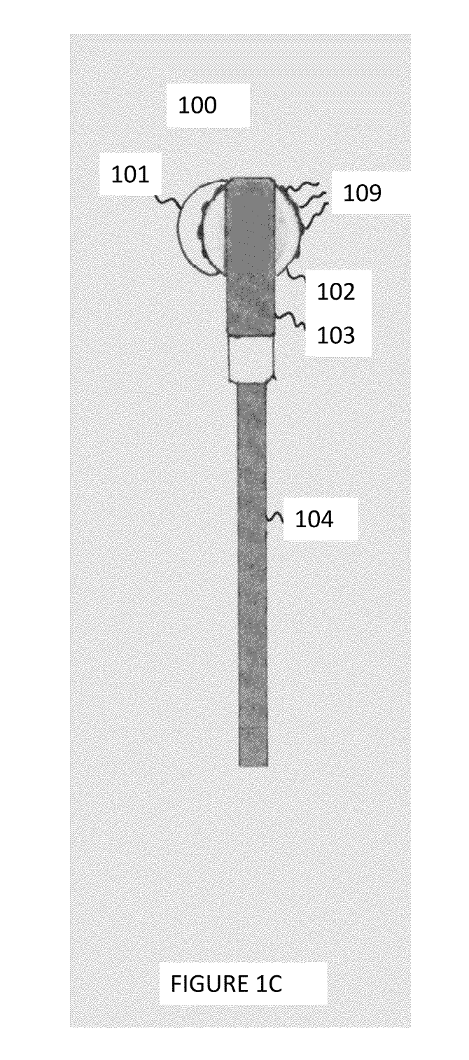

An exemplary assembly 100 of the invention is provided in FIGS. 1A, 1B, and 1C, depicting front, side, and rear views, respectively. The assembly 100 provided in FIGS. 1A-C depicts an ear pad 101 connected to a sound chamber 102 enclosed in a housing unit 103. A wire 104 travels from sound chamber 102 through the housing unit 103 for connection to an audio device. In this assembly 100, the sound chamber 102 has a mesh cover 105 at the end where sound travels out the chamber 102. Surrounding the sound chamber 102 is a band 106 of movement-resistant material, which serves to secure the earphone assembly 100 within the ear. In this embodiment, the band has a plurality of ridges 109 on the surface, which further serve to secure the assembly 100 in the ear. As shown in FIGS. 1A-C, the housing unit 103 still allows a significant portion of the band 106 to be exposed, thus maximizing contact once the assembly 100 is placed inside the ear.

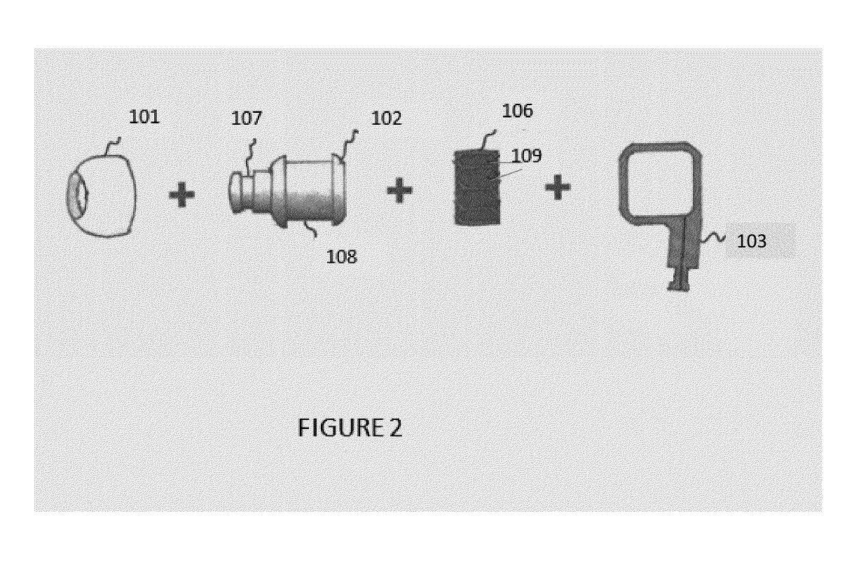

An exploded view of an exemplary assembly 100 of the invention is provided in FIG. 2. As shown, the assembly 100 includes an ear pad 101, a sound chamber 102, a band 106 of movement-resistant material, and a housing component 103. The sound chamber 102 features a first notch 107 to facilitate connection of the ear pad 101 and a second notch 108 to accommodate the movement-resistant band 106. As shown, the band 106 comprises ridges 109 that extend along the length of the band 106. The housing component 103 as shown in this embodiment is essentially a frame with sufficient space therein for accommodating the sound chamber 102 and band 106, while still permitting maximum exposure of the band 106 to an outside surface, such as an ear.

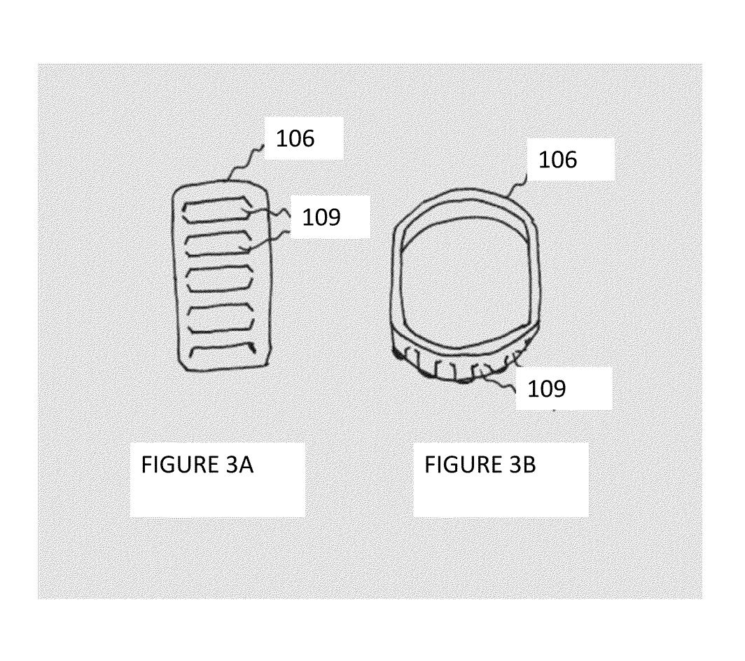

Another perspective of the movement resistant band is provided in FIGS. 3A and 3B, depicting side and front views, respectively. As shown, the band 106 features ridges 109 that extend along the length of the band 106. In this embodiment, the ridges 109 are uniformly distributed along the band 106. Although in preferred embodiments, the band 106 is prepared from a movement-resistant material, such as rubber, the ridges 109 further stabilize the band 106 once it is placed in the ear.

Taking the two sets of figures together, the benefits of the invention are apparent. When inserted into the ear, the ear bud headphone provides a stable fit due to the presence of the movement resistant material surrounding the sound chamber. Accordingly, headphone assemblies of the present invention are less likely to fall out during operation, thereby providing more enjoyment to the user.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

What is claimed is:

1. An earbud headphone assembly, the assembly comprising:
a sound chamber, and
a region located on the sound chamber adapted to grip an ear.

2. The earbud headphone assembly of claim 1, wherein the grip region is a band that extends around a circumference of the sound chamber.

3. The earbud headphone assembly of claim 1, wherein the grip region is prepared from a movement-resistant material.

4. The earbud headphone assembly of claim 3, wherein the movement-resistant material is rubber.

5. The earbud headphone assembly of claim 3, wherein the movement-resistant material has a plurality of protrusions on its surface.

6. The earbud headphone assembly of claim 5, wherein the plurality of protrusions are uniformly distributed along the surface of the movement-resistant material.

7. The earbud headphone assembly of claim 1, further comprising an ear pad connected to the sound chamber, wherein the ear pad is adapted for insertion into an ear.

8. The earbud headphone assembly of claim 1, further comprising a housing component, wherein the housing component encloses the sound chamber and grip region.
